(19) United States
(12) Patent Application Publication
(10) Pub. No.: US 2008/0198017 A1
(43) Pub. Date: Aug. 21, 2008

(54) Indentification of atennas via cables

(76) Inventors: Jan Hesselbarth, Sennhof (CH); Florian Pivit, Dublin (IE)

Correspondence Address: DOCKET ADMINISTRATOR;LUCENT TECHNOLOGIES INC., ROOM 2F-192, 600-700 MOUNTAIN AVENUE, MURRAY HILL, NJ, 07974-0636, US

(21) Appl. No.: 12/006,919

(22) Filed: Jan. 7, 2008

(30) Foreign Application Priority Data
Feb. 21, 2007 (FR) 07250723.9

(51) Int. Cl. G08B 13/14

(52) U.S. Cl. 340/572.4

(57) ABSTRACT

A method is provided of identifying an antenna, by the steps of: providing the antenna with an identifying radiofrequency identification RFID circuit, connecting one end of a cable to the antenna, connecting the other end of the cable to a remote unit, sending a trigger signal to the RFID circuit, receiving by the remote unit via the cable a response signal from the RFID circuit, and decoding the response signal so as to identify the antenna.

### FIELD OF THE INVENTION

The present invention relates to telecommunications, in particular to wireless telecommunications.

### DESCRIPTION OF THE RELATED ART

In deploying mobile phone base stations at a site, a ground-based unit usually needs to be connected to tower- or mast-mounted antennas by transmission lines such as coaxial cables. Correct connection between input/output ports of the ground-based unit and the antennas is crucial to successful operation of the base station, but connections are often mixed up. If such incorrect connections occur, an engineer must make a repeat visit to the site to deal with the problem. In order to see which cable is connected to which antenna, the engineer must usually climb the tower or use lifting equipment such as a crane. Furthermore, the base station is unusable until the antennas are correctly connected.

The known approach to avoiding incorrect connection is to colour code, or label, the cables and corresponding antennas. These approaches have disadvantages.

### SUMMARY OF THE INVENTION

The present invention is defined n the independent claims, to which the reader is now referred. Preferred features are laid out in the dependent claims.

An example of the present invention is a method of identifying an antenna by the steps of: providing the antenna with an identifying radiofrequency identification RFID circuit, connecting one end of a cable to the antenna, connecting the other end of the cable to a remote unit, sending a trigger signal to the RFID circuit, receiving by the remote unit via the cable a response signal from the RFID circuit, and decoding the received response signal so as to identify the antenna.

This approach allows remote identification from the ground of elevated antennas. The remote unit can be a base unit, for example at ground level. This remote identification is particularly useful if an incorrect connection has occurred.

The existing cable connection to an antenna is made use of. Other connections such as data busses or optical fibre links are not required.

By communicating with RF-ID tags in antennas via cables, the antennas can be distinguished, for example, during installation and when in use. This aids correct installation and operation of a base station.

### BRIEF DESCRIPTION OF THE DRAWINGS

Embodiments of the present invention will now be described by way of example and with reference to the drawings, in which:

FIG. 1 is a diagram illustrating a base station for wireless telecommunications according to a first embodiment of the invention,

FIG. 2 is a diagram illustrating how, in the base station shown in FIG. 1, an antenna is connected to a transceiver on the ground,

FIG. 3 is a schematic cross-sectional partial view illustrating an RF-ID tag within the antenna shown in FIG. 2,

FIG. 4 is a diagram illustrating connection of a test apparatus to the antenna so as to read the RF-ID tag,

FIG. 5 is a diagram illustrating a second embodiment having an add-on RF-ID tag connected between an antenna and coaxial cable.

The drawings are not to scale but are schematic representations.

### DETAILED DESCRIPTION

An example base station and its antenna are first described. Then an example method of reading the RFID tag in the antenna is explained. After that, some alternative examples are considered.

### The Base Station

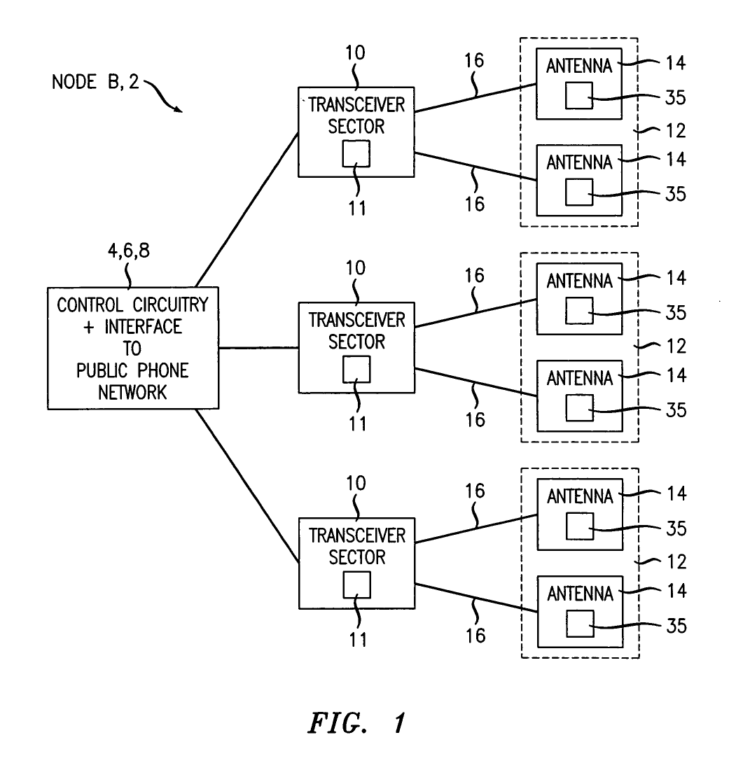

As shown in FIG. 1, an example base station 2, which happens to be of Universal Mobile Telecommunications System (UMTS) type, consists of a control module 4 including control circuitry 6 and an interface 8 to the public phone network (not shown). The control module is connected to transceivers 10, themselves each connected to a corresponding antenna assembly 12.

A cell (not shown), also referred to as a sector, is the radio-coverage area served by a corresponding antenna assembly 12 of the base station 2. The base station typically has three cells, each covered by one of three antenna assemblies 12 that are directional, angled at 120 degrees to each other in azimuth. Each antenna assembly 12 consists of two antennas 14, each of which is, for example, polarized in a single direction orthogonal to that of the other antenna 14 in the same antenna assembly 12, so as to make use of so-called antenna diversity. Each antenna includes an RF-ID circuit 35 explained in more detail below.

Each transceiver 10 includes a test apparatus 11 described in more detail below.

As will be seen in FIG. 1, there are six cables 16 between the antennas 14 and transceivers 10 in the base station 2.

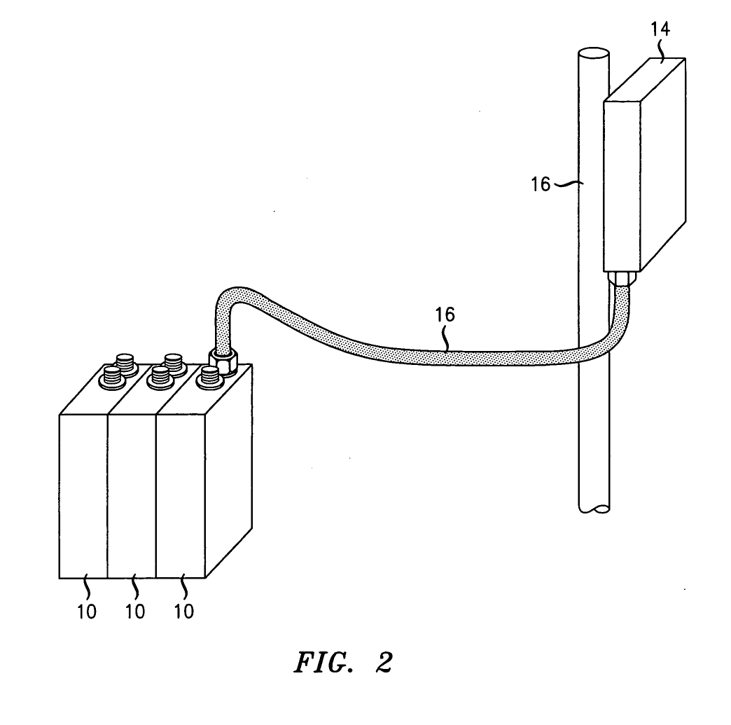

As shown figuratively in FIG. 2, the transceivers 10 are located at ground level, whereas the antennas 14 are located at elevated positions, typically 10 to 30 metres above ground, such as on high buildings or towers, such as on a mounting post 18 at the top of a tower (not shown). Each cable 16 is a coaxial cable.

### Antennas

An RF-ID tag is coupled to the input port of the antenna, for use in identification of the antenna.

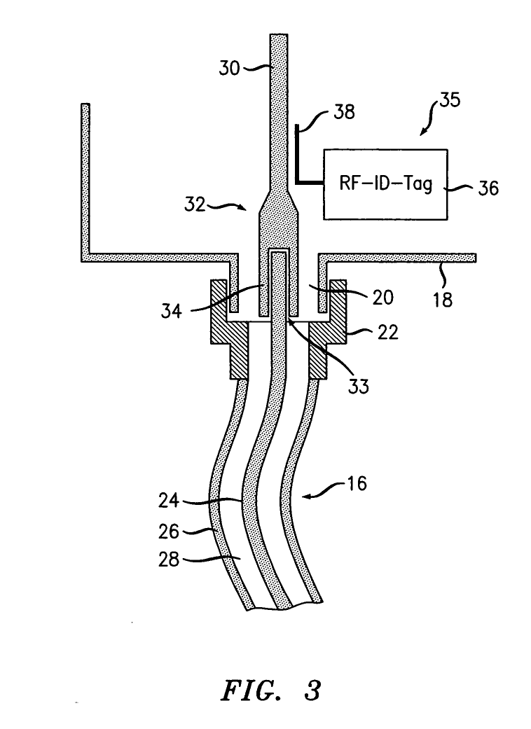

Referring to FIG. 3, the antenna 14 includes a housing, a part 18 of which is shown in the Figure. That part 18 of the housing includes an input/output port 20, to which an end connector 22 of the coaxial cable 16 is connected. The coaxial cable 16 includes an inner conductor 24, an outer conductor 26 and a dielectric material 28 in between. The outer conductor 26 contacts the part 18 of the housing. The inner conductor 24 is connected to a stripline conductor 30 which includes a connecting portion 32 having a recess 33 to fit an end 34 of the inner conductor 24 for good electrical connection.

A radio frequency identification, RF-ID, circuit 35 consists of a known RF-ID tag 36 and a directional coupler 38, by which the tag 36 is coupled to the stripline conductor 30. In this example embodiment inductive coupling is used.

Dependent upon the type of RF-ID tag, coupling of the tag to the transmission line, such as stripline, within the antenna can be done by inductive coupling, capacitive coupling, resistive coupling or a combination thereof.

In this embodiment, the RF-ID tag 36 is of a passive nature, of known type, as used, for example in known warehouse inventory systems. The RF-ID tag responds to a trigger signal sent up to the antenna via the coaxial cable 16 to send a response signal down via the coaxial cable 16. The response signal includes identification in the form of an antenna identification number. The response signal also includes information about the antenna, namely frequency range, gain, and polarisation, which can be used to monitor the operation of the base station.

In some other embodiments, the RF-ID tag 36 is of an active nature, making use of direct current, DC, power supplied by the coaxial cable 16.

### Reading the Tag

As shown in FIG. 1, a test apparatus 11 in a transceiver 10 sends a radio frequency trigger signal to the antenna 14 connected via a coaxial cable 16 to the transceiver 10. The trigger signal is at a different frequency to both the transmit band and the receive band of the transceiver 10 so as to ensure that the trigger signal does not get radiated by the antenna nor get treated as a received signal. This ensures compliance with requirements regarding such unwanted emissions.

This trigger signal triggers the response signal from the RF-ID tag 36. The tag 36 is coupled by the directional coupler 38 such that there is no substantial impairment to normal antenna operation. As mentioned previously, the response signal includes an antenna identification number which can be considered as an individual signature identifying the antenna.

A response signal is, of course, an identifier that the coaxial cable 16 is properly connected between a transceiver and antenna.

Normally response signals will includes the identification number of the antenna to which a transceiver is expected to be connected. However if an “incorrect” antenna is identified, remedial action is taken. For example, during installation of the base station 2, the installation technician on the ground can identify which antenna 14 is connected to which coaxial cable 16. This aids correct connection of antennas to transceivers.

Secondly, after installation such that the base station is powered up and in operation, triggering the RF tag provides useful information for maintenance purposes. For example the failure to receive a response signal could indicate that an antenna to which the trigger signal is sent is not properly connected. Correct responses from some antennas but not others could help to pin-point where in the base station a faulty component lies. In consequence, so-called base station down-time, during which repairs are effected, can be reduced.

The RF-ID tags enable antennas to be identified from the ground.

### Alternative Test Apparatus for Use During Base Station Installation

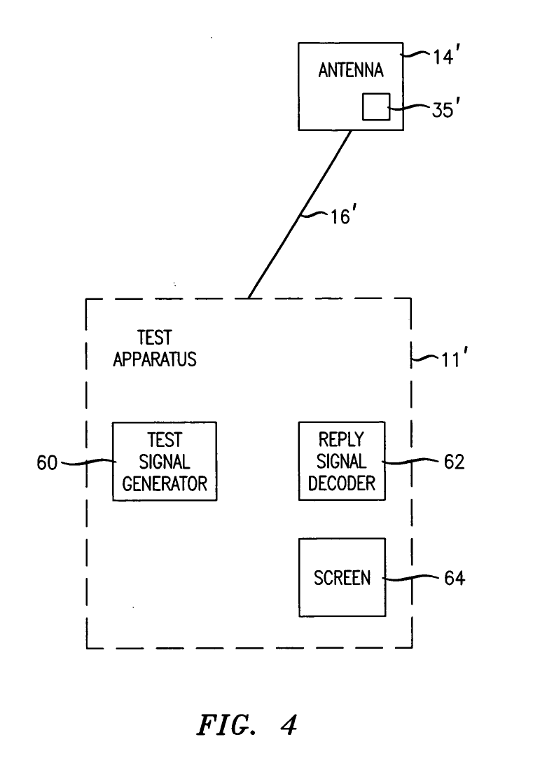

In installing a base station, coaxial cables connected to antennas are identified by a human installer on the ground so as to work out to which transceiver each coaxial cable should be connected. To do this, as shown in FIG. 4, the installer connects a handheld tester unit 11′ to the end of the coaxial cable 16′ distal from the antenna 14′. The handheld tester unit 11′ includes a test signal generator 60, a reply signal decoder 62 and a visual display screen 64. The test signal generator 60 generates a trigger signal. The trigger signal is sent up the coaxial cable 16′ and it is that signal to which the RF-ID circuit 35′in the antenna 14′ responds. The response signal is decoded in a decoder 62 to provide an antenna identification number that is displayed on the screen 64.

### Other Embodiments

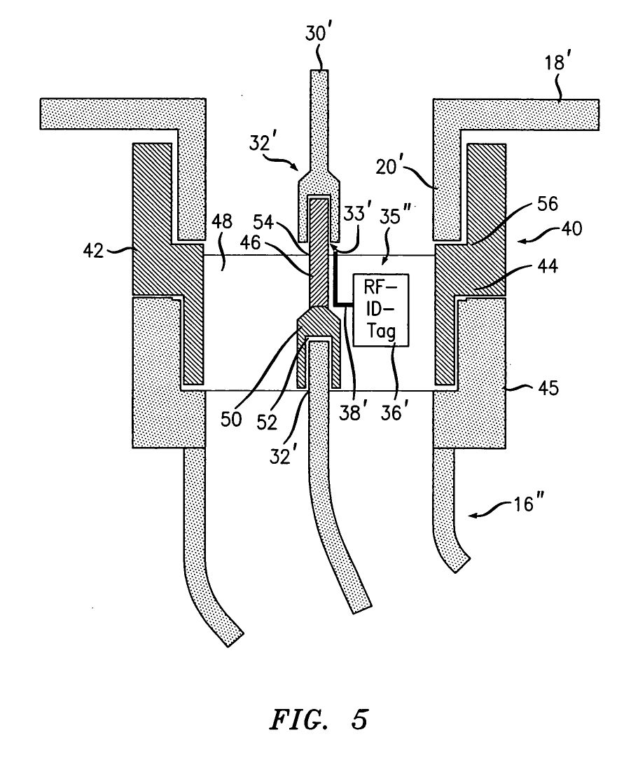

As shown on FIG. 5, as an alternative to having the RF-ID circuit within the antenna housing, the RF-ID circuit 35″ is placed in an add-on unit 40.

The add-on unit 40 comprises a threaded cylindrical outer conductor 42 having a cylindrical outer shoulder 44 portion, which, when fitted, abuts the female connector end 45 of the coaxial cable 16″.

The add-on unit 40 also includes an inner conductor element 46 held in position relative to the outer conductor 42 by a dielectric material 48. The inner conductor element 46 includes a base portion 50 and a top portion 54. The base portion 50 includes a cylindrical recess 52 shaped to fit over, and electrically connect with, the end of the inner conductor 32′ of the coaxial cable 16′. The top portion 54 is a cylindrical conductor.

In use, the top portion 54 is connected to a stripline conductor 30′ which includes a connection portion 32′ having a recess 33′ to fit said top portion 54 with good electrical connection.

As shown in FIG. 5, the antenna 14′ includes a housing, part 18′ of which is shown that includes an input/output port 20′ threaded and shaped for cooperative inter-engagement with a cylindrical inner shoulder portion 56 of the add-on unit 40.

The RF-ID circuit 35″ consists of an RF-ID tag 36′ of known type and a coupler such as a directional coupler 38′ by which the tag 36′ is coupled to the top portion 54 of the inner conductor element 46.

In some other, otherwise similar, embodiments (not shown) other types of cable are used in place of stripline, for example waveguide or coaxial cable. The stripline conductor 30, 30′ can be replaced by a coaxial inner conductor.

In some embodiments, the trigger signal may be in the transmit band and/or receive band of the antenna rather than outside these bands.

In some embodiments, the base station is a CDMA2000 base station or another type of base station for wireless telecommunications. Base stations can be of various standards and frequency bands.

In some embodiments, the antennas are dual-band antennas with connectors in each band. In some embodiments, a single, dual polarised, antenna is used in each cell so as to exploit antenna diversity.

In some embodiments, the antenna is intelligent, and other intelligent elements in the system include apparatus to remotely identify antennas having RF-ID tags, and then address control signals to those antennas. This enables automatic discovery and configuration processes in intelligent systems, including monitoring of antenna operation to determine whether an antenna is operating correctly.

In some embodiments, rather than the cable being a coaxial cable or stripline, the cable can by some other type of transmission line or waveguide.

### General

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of identifying an antenna, comprising the steps of:
providing the antenna with an identifying radiofrequency identification, RFID, circuit;
connecting one end of a cable to the antenna;
connecting the other end of the cable to a remote unit;
sending a trigger signal to the RFID circuit;
receiving by the remote unit via the cable a response signal from the RFID circuit; and
decoding the received response signal so as to identify the antenna.

2. A method according to claim 1, in which the trigger signal is sent to the RFID circuit via the cable.

3. A method according to claim 1, in which the remote unit comprises a base station transceiver.

4. A radio telecommunications base station comprising an antenna, a base unit, and a cable to connect the antenna to the base unit;
the antenna comprising a radiofrequency identification, RFID, circuit;
the base unit including means to transmit a trigger signal to the RFID circuit, means to receive a reply signal from the RFID circuit via the cable, and means to decode the received reply signal.

5. A base station according to claim 4, in which the RFID circuit is within a main housing of the antenna.

6. A base station according to claim 4, in which the RFID circuit is housed in a connector for connection between a main housing of the antenna and the cable.

7. A base station according to claim 4, wherein the base unit comprises at least one transceiver, each transceiver comprising at least one port for connection to an antenna, each transceiver also comprising a test apparatus operative to send a test signal via the cable to the RFID circuit and to receive and decode a response signal from the RFID circuit via the cable so as to identify the antenna.

8. A base station according to claim 4, in which the RFID circuit comprising an RFID tag and a coupler, the tag being coupled to an electromagnetic wave guiding conductor of the cable by the coupler.

9. An RFID circuit assembly comprising an RFID tag,
the circuit also comprising a coupler and an electromagnetic wave guiding conductor, the tag being coupled to the conductor by the coupler.

10. An RFID circuit assembly according to claim 9, wherein the conductor comprises the inner conductor of a coaxial cable connector,
the assembly being shaped and configured to connect between a coaxial cable connector and a corresponding connector on a housing of an antenna.
